(19) United States
(12) Patent Application Publication
(10) Pub. No.: US 2006/0133516 A1
(43) Pub. Date: Jun. 22, 2006

(54) Method of coding data and transmitter

(75) Inventors: Andreas Pascht, Rudersberg (DE); Peter Jaenecke, Straubenhardt (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/296,325

(22) Filed: Dec. 8, 2005

(30) Foreign Application Priority Data
Dec. 17, 2004 (EP) 04293042.0

(51) Int. Cl. H04B 14/04

(52) U.S. Cl. 375/242

(57) ABSTRACT

A method of coding data, wherein a coding signal is used for coding data symbols, the coding signal comprising an orthogonal component and an error component, wherein a transmission signal depending on the data symbols and the coding signal is obtained by the coding, wherein the transmission signal is preferably obtained according to the equation

$$S ( f ) = {\sum }_{n = 1}^{N} {d}_{n} {ψ}_{n} ( f ) ,$$

wherein N is the number of data symbols to be coded. The method determines a correction function and applies the correction function to the transmission signal in order to obtain a corrected transmission signal.

### BACKGROUND OF THE INVENTION

The invention is based on a priority application EP 04293042.0 which is hereby incorporated by reference.

The present invention relates to a method of coding data, wherein a coding signal is used for coding data symbols, said coding signal comprising an orthogonal component and an error component, wherein a transmission signal depending on said data symbols and said coding signal is obtained by said coding, wherein the transmission signal is preferably obtained according to the equation

$$S ( f ) = {\sum }_{n = 1}^{N} {d}_{n} {ψ}_{n} ( f ) ,$$

wherein ψₙ(ƒ) is the coding signal and N is the number of data symbols (d₁, d₂, . . . , d_{N}) to be coded.

The present invention also relates to a transmitter comprising means for coding data symbols in order to obtain a transmission signal depending on said data symbols and a coding signal.

Coding methods of the aforementioned kind are applied in contemporary data transmission systems, and orthogonality conditions relating to the coding signal are used for decoding data previously so coded.

More specifically, such coding methods are for instance used within orthogonal code division multiplexing (OCDM) systems and orthogonal frequency division multiplexing (OFDM) systems.

### SUMMARY OF THE INVENTION

When implementing the above coding methods on computer systems, an undesired error component is introduced to the coding signal due to the finite precision of computer systems leading to a wrong data representation of values of the coding signal. This error component can e.g. be represented by an addend to the solely desired orthogonal component of the coding signal and leads to a violation of the orthogonality conditions, as far as the aggregate coding signal, i.e. the sum of the orthogonal component and the error component is concerned. I.e., the aggregate coding signal does no longer satisfy said orthogonality conditions.

The coding signal may e.g. be represented as
ψₙ(ƒ)=ψₙ⁰(ƒ)+Δψₙ(ƒ),
wherein ψₙ⁰(ƒ) denotes the orthogonal component and Δψₙ(ƒ) denotes the error component of said coding signal.

Using such a prior art coding method and signal within transmission and/or communication systems leads to inter-symbol interference (abbr.: ISI), wherein the absolute value of the ISI corresponds to the degree of violation of the respective orthogonality conditions.

In view of these disadvantages of contemporary coding methods, it is an object of the present invention to provide an improved method of coding data that avoids ISI.

According to the present invention, this object is solved for a coding method of the above mentioned type by determining a correction function and by applying said correction function to said transmission signal in order to obtain a corrected transmission signal.

Thus it is possible to reduce or even eliminate ISI which reduces errors when decoding the inventive corrected transmission signal.

According to an advantageous embodiment of the present invention, said step of applying the correction function is preferably performed by adding and/or subtracting said correction function to/from said transmission signal, which requires only few computational resources and which does not introduce further unnecessary e.g. numerical errors. It is also possible to apply the correction function to the transmission signal by multiplication. However, in this case, an approach of determining the correction function might be more complicated as compared to an approach of adding the correction function to the transmission signal.

A further advantageous embodiment of the present invention is characterized by determining said correction function depending on the coding signal, in particular depending on the error component (Δψₙ(ƒ)) of the coding signal (ψₙ(ƒ)).

According to another advantageous embodiment of the present invention, said method is characterized in that said correction function is determined depending on an ISI-term corresponding to an inter-symbol interference (ISI) that occurs when coding said data symbols. Preferably, said correction function is determined so as to minimize the ISI-term.

Yet another advantageous embodiment of the present invention is characterized in that said orthogonal component ψₙ⁰(ƒ) of said coding signal ψₙ(ƒ) satisfies an orthogonality condition, in particular the orthoquality condition

$${\int }_{- ∞}^{+ ∞} ⅆ f {ψ}_{n}^{0} ( f ) {H}_{k} ( f ) = {χ}_{k} {δ}_{nk} ,$$

wherein k,n=1, . . . , N, wherein Hₖ(ƒ) is the Hermite polynomial of k-th order, χₖ is a known constant, and wherein δₙₖ is the Kronecker symbol.

The Hermite polynomial may be written as

$${H}_{k} ( f ) = {( - 1 )}^{k} {ⅇ}^{{f}^{2}} \frac{{ⅆ}^{n}}{ⅆ {f}^{n}} {ⅇ}^{- {f}^{2}} .$$

Instead of using Hermite polynomials, according to a further advantageous embodiment of the present invention any other set of orthogonal functions may also be employed to define the coding signal, or its orthogonal component, respectively. In this case, of course, a corresponding orthogonality condition must be used that fits to the respective coding signal.

According to a further advantageous embodiment of the present invention, the ISI-term εₖ is obtained according to the equation

$${ɛ}_{k} = {\int }_{- ∞}^{+ ∞} ⅆ {fH}_{k} ( f ) {\sum }_{n = 1}^{N} {d}_{n} Δ {ψ}_{n} ( f ) ,$$

wherein Hₖ(ƒ) is the Hermite polynomial of k-th order, Δψₙ(ƒ) is said error component, and wherein

$$ξ ( f ) = {\sum }_{n = 1}^{N} {d}_{n} Δ {ψ}_{n} ( f )$$

constitutes said correction function.

A further solution to the object of the present invention is given by a transmitter comprising means for coding data symbols (d₁, d₂, . . . , d_{N}) in order to obtain a transmission signal (S(ƒ)) depending on said data symbols (d₁, d₂, . . . , d_{N}) and a coding signal (ψₙ(ƒ)), characterized by further comprising predistortion means capable of determining a correction function (ξ(ƒ)) and of applying said correction function (ξ(ƒ)) to said transmission signal (S(ƒ)) in order to obtain a corrected transmission signal (S_{pd}(ƒ)).

### BRIEF DESCRIPTION OF THE DRAWINGS

Further applications, features and advantages of the present invention are described in the following detailed description with reference to the drawings, in which

FIG. 1a depicts results corresponding to the inventive coding method,

FIG. 1b depicts further results corresponding to the inventive coding method, and

FIG. 2 gives a graphical representation of the results according to the table of FIG. 1a.

### DETAILED DESCRIPTION OF THE INVENTION

According to a first embodiment of the present invention, a coding signal
ψₙ(ƒ)=ψₙ⁰(ƒ)+Δψₙ(ƒ), (equation 1)
is used for coding data, wherein ψₙ⁰(ƒ) denotes an orthogonal component and Δψₙ(ƒ) denotes an error component of said coding signal ψₙ(ƒ).

The orthogonal component ψₙ⁰(ƒ) satisfies the orthogonality condition

$${\int }_{- ∞}^{+ ∞} ⅆ f {ψ}_{n}^{0} ( f ) {H}_{k} ( f ) = {χ}_{k} {δ}_{nk} , \qquad ( equation 2 )$$

wherein k,n=1, . . . , N, wherein Hₖ(ƒ) is the Hermite polynomial of k-th order, χₖ is a known constant, and wherein δₙₖ is the Kronecker symbol.

The error component Δψₙ(ƒ) symbolizes a deviation of the coding signal ψₙ(ƒ) from an ideal coding signal ψ_{n,ideal}(ƒ), which solely comprises an orthogonal component:
ψ_{n,ideal}(ƒ)=ψₙ⁰(ƒ).

Said error component Δψₙ(ƒ) of the coding signal ψₙ(ƒ)=ψₙ⁰(ƒ)+Δψₙ(ƒ) is e.g. due to a data representation of said ideal coding signal ψ_{n,ideal}(ƒ) by means of data types such as used within a computer system or a digital signal processor (DSP), respectively, which offer finite precision.

The data to be coded is provided in form of data symbols d₁, d₂, . . . , d_{N}, each of which comprises a data word length of e.g. 18 bit, and a transmission signal S(ƒ) according to

$$S ( f ) = {\sum }_{n = 1}^{N} {d}_{n} {ψ}_{n} ( f ) \qquad ( equation 3 )$$

is obtained by said coding. Said transmission signal S(ƒ) is given in the frequency domain in the present example and depends on said data symbols d₁, d₂, . . . , d_{N} as well as on said coding signal ψₙ(ƒ).

In order to obtain the coded data symbols e.g. withina receiver, the already above described orthogonality condition

$${\int }_{- ∞}^{+ ∞} ⅆ f {ψ}_{n}^{0} ( f ) {H}_{k} ( f ) = {χ}_{k} {δ}_{nk}$$

of equation 2 is used, wherein decoded symbols Tₖ, k=1, . . . , N, are obtained according to the following equation:

$${T}_{k} = {\int }_{- ∞}^{+ ∞} ⅆ fS ( f ) {H}_{k} ( f ) .$$

In the ideal case, i.e. when using the ideal coding signal
ψ_{n,ideal}(ƒ)=ψₙ⁰(ƒ),
an ideal transmission signal

$${S}_{ideal} ( f ) = {\sum }_{n = 1}^{N} {d}_{n} {ψ}_{n , ideal} ( f ) ,$$

and thus ideally decoded data symbols T_{k,ideal}, k=1, . . . , N, under ideal conditions of infinite precision may be obtained:

$$\begin{matrix}{T}_{k , ideal} = {\int }_{- ∞}^{+ ∞} ⅆ f {S}_{ideal} ( f ) {H}_{k} ( f ) \\ = {\int }_{- ∞}^{+ ∞} ⅆ f {\sum }_{n = 1}^{N} {d}_{n} {ψ}_{n , ideal} ( f ) {H}_{k} ( f )\end{matrix}$$

$$\begin{matrix}{T}_{k , ideal} = {\sum }_{n = 1}^{N} {d}_{n} {\int }_{- ∞}^{+ ∞} ⅆ f {ψ}_{n , ideal} ( f ) {H}_{k} ( f ) \\ = {χ}_{k} {d}_{k} ,\end{matrix}$$

wherein χₖ=const. and k=1, . . . , N I.e., in the ideal case with a vanishing error component Δψₙ(ƒ)=0, a perfect reconstruction by decoding said ideal transmission signal S_{ideal}(ƒ) in the above way is possible:

$${d}_{k} = \frac{{T}_{k , ideal}}{{χ}_{k}} .$$

Within real applications, there is usually a nonvanishing error component Δψₙ(ƒ) which leads to the following term when coding/decoding according to prior art methods:

$$\begin{matrix}\begin{matrix}{T}_{k} = {\int }_{- ∞}^{+ ∞} ⅆ f S ( f ) {H}_{k} ( f ) \\ = {\int }_{- ∞}^{+ ∞} ⅆ f {\sum }_{n = 1}^{N} {d}_{n} {ψ}_{n} ( f ) {H}_{k} ( f )\end{matrix} \\ {T}_{k} = {\int }_{- ∞}^{+ ∞} ⅆ f {H}_{k} ( f ) {\sum }_{n = 1}^{N} {d}_{n} [ {ψ}_{n}^{0} ( f ) + Δ {ψ}_{n} ( f ) ] \\ \begin{matrix}{T}_{k} = {\int }_{- ∞}^{+ ∞} ⅆ f {H}_{k} ( f ) {\sum }_{n = 1}^{N} {d}_{n} {ψ}_{n}^{0} ( f ) + \\ {\int }_{- ∞}^{+ ∞} ⅆ f {H}_{k} ( f ) {\sum }_{n = 1}^{N} {d}_{n} Δ {ψ}_{n} ( f )\end{matrix} \\ {T}_{k} = {χ}_{k} {d}_{k} + {ɛ}_{k} , \\ wherein & ( equation 4 ) \\ {ɛ}_{k} = {\int }_{- ∞}^{+ ∞} ⅆ f {H}_{k} ( f ) {\sum }_{n = 1}^{N} {d}_{n} Δ {ψ}_{n} ( f ) . & ( equation 5 )\end{matrix}$$

In difference to the ideal case, wherein the decoded symbols can be obtained with the equation

$${d}_{k} = \frac{{T}_{k , ideal}}{{χ}_{k}} ,$$

in the real case there is an unwanted term εₖ according to equation 5, which is denoted as a so-called ISI-term εₖ for the further description, since it symbolizes an unwanted inter-symbol interference that is occurring in the real case when using prior art coding methods.

Said ISI-term εₖ is particularly disadvantageous when using modulation schemes of higher order and impairs a correct decoding of data symbols.

Accordingly, the coding method of the present invention comprises determining a correction function ξ(ƒ) which is applied to the transmission signal S(ƒ) and which effects a predistortion of the transmission signal S(ƒ) whereby a corrected transmission signal S_{pd}(ƒ) is obtained:

$${S}_{pd} ( f ) = S ( f ) - ξ ( f ) = {\sum }_{n = 1}^{N} {d}_{n} {ψ}_{n} ( f ) - ξ ( f )$$

Said inventive correction function ξ(ƒ) is determined in order to reduce or even eliminate said unwanted ISI-term εₖ thus enabling a correct decoding of coded data symbols.

For determining the inventive correction function ξ(ƒ), the following approach is adopted:

The decoding of a corrected transmission signal S_{pd}(f) leads to decoded data

$${T}_{k , pd} = {\int }_{- ∞}^{+ ∞} ⅆ {fS}_{pd} ( f ) {H}_{k} ( f ) = {χ}_{k} {d}_{k} ,$$

k=1, . . . , N, which, as in the ideal case, does not comprise an ISI-term εₖ.

As a consequence of using the inventive corrected transmission signal S_{pd}(f), it is thus obtained

$${T}_{k , pd} = {\int }_{- ∞}^{+ ∞} ⅆ f [ S ( f ) - ξ ( f ) ] {H}_{k} ( f )$$

$${T}_{k , pd} = {\int }_{- ∞}^{+ ∞} ⅆ fS ( f ) {H}_{k} ( f ) - {\int }_{- ∞}^{+ ∞} ⅆ f ξ ( f ) {H}_{k} ( f ) ,$$

which leads to

$${T}_{k , pd} = {χ}_{k} {d}_{k} + {ɛ}_{k} - {\int }_{- ∞}^{+ ∞} ⅆ f ξ ( f ) {H}_{k} ( f ) = {χ}_{k} {d}_{k}$$

by using equation 4 which is described above.

Consequently, for the ISI-term εₖ it is found that:

$${ɛ}_{k} = {\int }_{- ∞}^{+ ∞} ⅆ f ξ ( f ) {H}_{k} ( f ) , \qquad ( equation 6 )$$

if T_{k,pd}=χₖ dₖ as demanded for a decoding without an influence of the ISI-term εₖ.

When comparing equation 5 with equation 6,

$${\int }_{- ∞}^{+ ∞} ⅆ {fH}_{k} ( f ) {\sum }_{n = 1}^{N} {d}_{n} Δ {ψ}_{n} ( f ) = {\int }_{- ∞}^{+ ∞} ⅆ f ξ ( f ) {H}_{k} ( f ) ,$$

it can be seen that

$$ξ ( f ) {=}^{!} {\sum }_{n = 1}^{N} {d}_{n} Δ {ψ}_{n} ( f ) ,$$

i.e. said inventive correction function ξ(ƒ) depends on the data symbols dₙ and the error component Δψₙ(ƒ).

For calculating the inventive correction function ξ(ƒ), equations 4 and 6 are used:

$${\int }_{- ∞}^{+ ∞} ⅆ f ξ ( f ) {H}_{k} ( f ) = {T}_{k} - {χ}_{k} {d}_{k} ,$$

wherein by means of discrete integration the equation

$${\int }_{l = 1}^{L} Δ {fH}_{k} ( {f}_{1} ) ξ ( {f}_{1} ) = {T}_{k} - {χ}_{k} {ⅆ}_{k} , ( k = 1 , 2 , … , N ) \qquad ( equation 7 )$$

is obtained which leads to the equation system:
Hₖ(ƒ₁)ξ(ƒ₁)+Hₖ(ƒ₂)ξ(ƒ₂)+ . . . +Hₖ(ƒ_{L})ξ(ƒ_{L})=γₖ, k=1,2, . . . , N (equation 8)
with

$${H}_{k} ( {f}_{1} ) ξ ( {f}_{1} ) + {H}_{k} ( {f}_{2} ) ξ ( {f}_{2} ) + … + {H}_{k} ( {f}_{L} ) ξ ( {f}_{L} ) = {γ}_{k} , k = 1 , 2 , … , N \\ with \\ {γ}_{k} = \frac{1}{Δ f} ( {T}_{k} - {χ}_{k} {d}_{k} ) , ( k = 1 , 2 , … , L ) . \qquad ( equation 8 )$$

The discrete integration used to obtain equation 7 generally enables to replace the integral term

$${\int }_{- ∞}^{+ ∞} ⅆ fu ( f )$$

comprising a function u(f) by the term

$${\int }_{l = 1}^{L} Δ fu ( f ) = Δ f \cdot {\sum }_{l = 1}^{L} u ( {f}_{l} ) ,$$

as long as u(f) is nonzero only within a certain range −ƒ_{g}≦ƒ≦+ƒ_{g} and u(f) is only defined for discrete values of the variable f, wherein Δƒ=ƒₗ₊₁−ƒₗ=const. for l=1, . . . , L−1, which in the present example holds true for Hₖ(f) ξ(f).

Since there are L many unknowns ξ(ƒ₁), . . . , ξ(ƒ_{L}) within equation system 8, L equations are required for solving the equation system. However, as can be seen from equation 7, there are only N many unknowns to be dealt with because of k=1, . . . , N; thus it is sufficient to consider only N many unknowns, e.g. the N first unknowns ξ(ƒ₁), . . . , ξ(ƒ_{N}), of equation system 8. The remaining unknowns ξ(ƒ_{N+1}), . . . , ξ(ƒ_{L}) can be set to zero. Accordingly, a simplified equation system is obtained:
Hₖ(f₁)ξ(f₁)+Hₖ(f₂)ξ(f₂)+ . . . +Hₖ(fₙ₋₁)ξ(f_{N-1})+Hₖ(f_{N})ξ(f_{N})=γₖ (equation 9)

After solving the above equation system, the values ξ(ƒ₁), . . . , ξ(ƒ_{N}) of the correction function ξ(ƒ) are known and can be used to correct the transmission signal S(f) according to:

$${S}_{pd} ( f ) = S ( f ) - ξ ( f ) = {\sum }_{n = 1}^{N} {d}_{n} {ψ}_{n} ( f ) - ξ ( f ) .$$

Consequently, by using the corrected transmission signal, the ISI-term εₖ can be minimized, cf. equation 6.

A further embodiment of the present invention is characterized by a coding signal
Ψₙ(ƒ)=Hₙ(ƒ)·e^{-ƒ}^{²}+ΔΨₙ(ƒ),
i.e. ψₙ⁰(ƒ)=Hₙ(ƒ)e^{-ƒ}^{²}, wherein Hₙ(ƒ) is the Hermite polynomial of n-th order.

The present embodiment is further characterized by said transmission Signal S(f) comprising two sub-signals I(f) and Q(f), which may e.g. represent an in-phase component I(f) of the transmission signal S(f) and a quadrature component Q(f), respectively:
S(ƒ)=I(ƒ)+iQ(ƒ), (equation 10)
wherein said sub-signals I(f) and Q(f) are defined within a frequency range f=μ[−ƒ_{g},−ƒ_{g}+Δ_{ƒ},−ƒ_{g}+2Δƒ,−ƒ_{g}+3Δƒ, . . . , 0,Δƒ, . . . , +ƒ_{g}], ƒ_{g}=2.5 MHz, wherein μ constitutes a parameter that may be re-calculated.

Said frequency range f may also be denoted as f={ƒ₁, ƒ_{2,} . . . ƒ_{L}}, wherein L may e.g. be 16 or 32. The sub-signal I(f) is determined by data symbols and Hermite polynomials having an odd index:

$$I ( f ) = {\sum }_{n = 1}^{{N}_{0}^{odd}} {d}_{2 n - 1} {Ψ}_{2 n - 1} ( f ) ,$$

whereas the sub-signal Q(f) is determined by data symbols and Hermite polynomials having an even index:

$$\begin{matrix}Q ( f ) = {\sum }_{n = 1}^{{N}_{0}^{even}} {d}_{2 n} {Ψ}_{2 n} ( f ) , wherein \\ {Ψ}_{n} ( f ) = {H}_{n} ( f ) {e}^{- {f}^{2}} + {ΔΨ}_{n} ( f ) \\ {N}_{0}^{odd} = ( {N}_{odd} + 1 ) / 2 \\ {N}_{0}^{even} = {N}_{even} / 2 , \\ {N}_{odd} = \{ \begin{matrix}N - 1 if N is even \\ N if N is odd\end{matrix} \\ {N}_{even} = \{ \begin{matrix}N if N is even \\ N - 1 if N is odd\end{matrix}\end{matrix}$$

In order to decode the data symbols dₙ, n=1,3, . . . N_{odd} and dₙ, n=2,4, . . . , Nₑᵥₑₙ, respectively, the following equations must be considered for I(f) and Q(f), respectively:

$${T}_{k}^{I} = {\int }_{- ∞}^{+ ∞} ⅆ f {H}_{k} ( f ) I ( f ) = {\int }_{- ∞}^{+ ∞} ⅆ {fH}_{k} ( f ) {\sum }_{n = 1}^{{N}_{0}^{odd}} {d}_{2 n - 1} {Ψ}_{2 n - 1} ( f )$$

$${T}_{k}^{Q} = {\int }_{- ∞}^{+ ∞} ⅆ f {H}_{k} ( f ) Q ( f ) = {\int }_{- ∞}^{+ ∞} ⅆ f {H}_{k} ( f ) {\sum }_{n = 1}^{{N}_{0}^{even}} {d}_{2 n} {Ψ}_{2 n} ( f )$$

Thus, for the correction functions ξ_{I}(ƒ), ξ_{Q}(ƒ) is found:

$${ξ}_{I} ( f ) = {\sum }_{n = 1}^{{N}_{0}^{odd}} {d}_{2 n - 1} {ΔΨ}_{2 n - 1} ( f )$$

$${ξ}_{Q} ( f ) = {\sum }_{n = 1}^{{N}_{0}^{even}} {d}_{2 n} {ΔΨ}_{2 n} ( f ) ,$$

and consequently, after solving the respective equation system for ξ_{I}(ƒ₁), . . . , ξ_{I}(ƒ_{N}) and ξ_{Q}(ƒ₁), . . . , ξ_{Q}(ƒ_{N}), which can be accomplished in analogy to solving equation system 8 as described above, corrected sub-signals I(f) and Q(f) and thus the corrected transmission signal S_{pd}(ƒ) can be obtained:
S_{pd}(ƒ)=S(ƒ)−ξ(ƒ)=I(ƒ)+iQ(ƒ)−ξ_{I}(ƒ)−iξ_{Q}(ƒ)

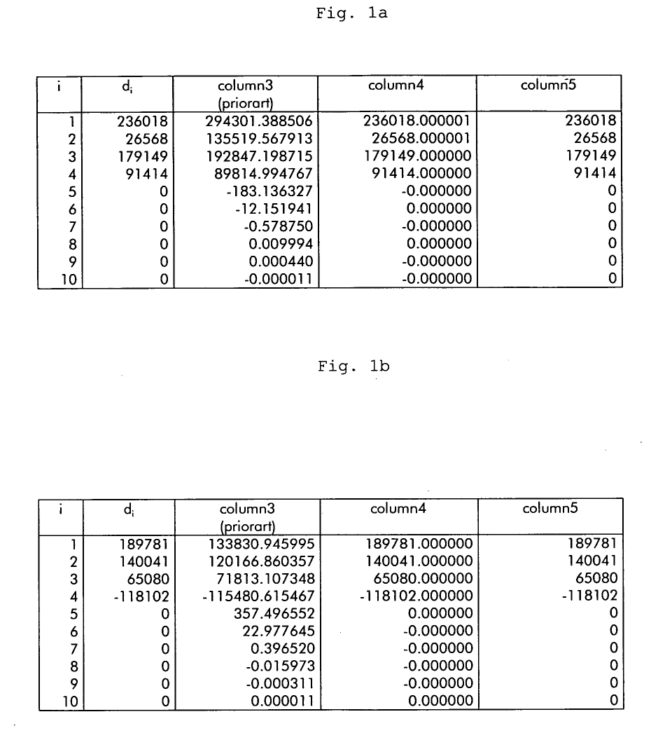

FIG. 1a depicts results corresponding to the inventive coding method applied to the sub-signal I(f) as used in the aforedescribed embodiment of the present invention in comparison with results achieved by prior art. The results are given in form of a table which contains in its first column an index number i ranging from 1 to 10 and denoting one of ten specific data symbols d₁ to d₁₀, which are presented in the second column denoted “dᵢ” of said table.

The third column of the table shown in FIG. 1a correspondingly comprises data symbols as can be obtained by decoding the previously coded data symbols d₁ to d₁₀, wherein the coding has been performed according to prior art methods, i.e. without using the inventive correction function ξ_{I}(ƒ) for predistorting the sub-signal I(f). A comparison of the data symbol values comprised within column 2 and column 3 shows a substantial deviation of the data symbol values of said columns, which is mainly due to an influence of the ISI-term that is not suppressed for obtaining the data symbol values of column 3.

Even for data symbol values of zero, i.e. for d₅ to d₁₀ according to column 2 of FIG. 1a, when using prior art methods, corresponding symbol values of decoded symbols are obtained ranging from 0.009994 to −183.136327 which leads to decoding errors.

When coding the data symbols of column 2 according to the inventive method, i.e. by applying the inventive correction function ξ_{I}(ƒ), the decoding yields data symbol values as given in column 4 of FIG. 1a, which do not show a substantial deviation from the original data symbol values of column 2.

Column 5 shows the data symbol values of column 4 rounded to zero decimals, which are equal to the respective values of column 2. Notably, even for the data symbols d₅ to d₁₀, having a value of zero, the corresponding values of column 4 or 5 show no deviation, which is due to the inventive suppression of inter-symbol interference by using the correction function ξ_{I}(ƒ).

Similar to FIG. 1a, FIG. 1b depicts the respective data symbols for coding/after decoding used in conjunction with the sub-signal Q(f).

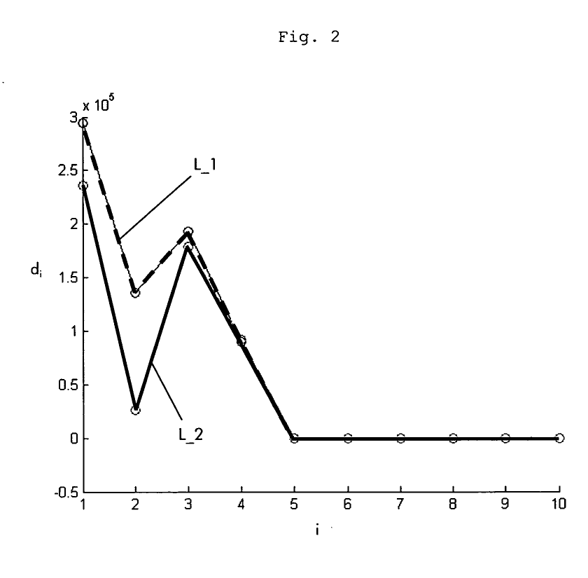

A graphical representation of the results according to the table of FIG. 1a is given by FIG. 2, in which the dashed line L_1 denotes the data symbol values of column 3, i.e. after decoding when using a prior art coding method without inventive correction function ξ_{I}(ƒ). Line L_2 denotes the data symbol values of column 2, i.e. the values of the data symbols to be coded, and at the same time the data symbol values of column 4, i.e. after decoding when using the inventive coding method comprising an application of the inventive correction function ξ_{I}(ƒ).

The present invention is not limited to using Hermite polynomials. Instead of using Hermite polynomials, according to a further advantageous embodiment of the present invention any other set of orthogonal functions may also be employed to define the coding signal, or its orthogonal component, respectively. In this case, of course, a corresponding orthogonality condition must be used that fits to the respective coding signal.

According to another embodiment of the present invention, it is also possible to define an in-phase component I(f) of the transmission signal S(f) and a quadrature component Q(f) according to

$$I ( f ) = {\sum }_{n = 1}^{N} {d}_{n}^{I} {Ψ}_{n} ( f ) , \\ Q ( f ) = {\sum }_{n = 1}^{N} {d}_{n}^{Q} {Ψ}_{n} ( f ) ,$$

wherein 2*N many data symbols dₙ^{I}, n=1, . . . , N, dₙ^{Q}, n=1, . . . , N may be coded which leads to the transmission signal
S(ƒ)=I(ƒ)+iQ(ƒ).

Coding said 2*N many data symbols in the above described manner, i.e. particularly by using the same coding signal Ψₙ(ƒ) for each sub-signal I(f), Q(f) can be performed since said in-phase component I(f) and said quadrature component Q(f) do not influence each other when forming said transmission signal S(f), because I(f) constitutes the real part of the transmission signal S(f) and Q(f) constitutes the imaginary part of the transmission signal S(f), and said real part and said imaginary part may be considered separately as far as coding by using the inventive method is concerned.

1. Method of coding data, wherein a coding signal (ψₙ(ƒ), n=1, . . . , N) is used for coding data symbols (d₁, d₂, . . . , d_{N}), said coding signal (ψₙ(ƒ)) comprising an orthogonal component (ψₙ⁰(ƒ)) and an error component (Δψₙ(ƒ)), wherein a transmission signal (S(ƒ)) depending on said data symbols (d₁, d₂, . . . , d_{N}) and said coding signal (ψₙ(ƒ)) is obtained by said coding, wherein the transmission signal (S(ƒ)) is preferably obtained according to the equation
$$S ( f ) = {\sum }_{n = 1}^{N} {d}_{n} {ψ}_{n} ( f ) ,$$
wherein N is the number of data symbols (d₁, d₂, . . . , d_{N}) to be coded, characterized by determining a correction function (ξ(ƒ)) and by applying said correction function (ξ(ƒ)) to said transmission signal (S(ƒ)) in order to obtain a corrected transmission signal (S_{pd}(ƒ)).

2. The method according to claim 1, wherein said applying is preferably performed by adding and/or subtracting said correction function (ξ(ƒ)) to/from said transmission signal (S(ƒ)).

3. The method according to claim 1, characterized by determining said correction function (ξ(ƒ)) depending on the coding signal (ψₙ(ƒ)), in particular depending on the error component (Δψₙ(ƒ)) of the coding signal (ψₙ(ƒ)).

4. The method according to claim 1, characterized in that said correction function (ξ(ƒ)) is determined depending on an ISI-term (εₖ, k=1, . . . , N) corresponding to an inter-symbol interference that occurs when coding said data symbols (dₖ, k=1, . . . , N).

5. The method according to claim 1, characterized in that said orthogonal component (ψₙ⁰(ƒ)) of said coding signal (ψₙ(ƒ)) satisfies an orthogonality condition, in particular the orthogonality condition
$${\int }_{- ∞}^{+ ∞} ⅆ f {ψ}_{n}^{0} ( f ) {H}_{k} ( f ) = {χ}_{k} {δ}_{nk ,}$$
wherein k,n=1, . . . , N, wherein Hₖ(ƒ) is the Hermite polynomial of k-th order, χₖ is a known constant, and wherein δₙₖ is the Kronecker symbol.

6. The method according to claim 4, wherein the ISI-term (εₖ) is obtained according to the equation
$${ɛ}_{k} = {\int }_{- ∞}^{+ ∞} ⅆ f {H}_{k} ( f ) {\sum }_{n = 1}^{N} {d}_{n} {Δψ}_{n} ( f ) ,$$
wherein Hₖ(ƒ) is the Hermite polynomial of k-th order, Δψₙ(ƒ) is said error component, and wherein
$$ξ ( f ) = {\sum }_{n = 1}^{N} {d}_{n} {Δψ}_{n} ( f )$$
is said correction function.

7. Transmitter comprising means for coding data symbols (d₁, d₂, . . . , d_{N}) in order to obtain a transmission signal (S(ƒ)) depending on said data symbols (d₁, d₂, . . . , d_{N}) and a coding signal (ψₙ(ƒ)), further comprising predistortion means capable of determining a correction function (ξ(ƒ)) and of applying said correction function (ξ(ƒ)) to said transmission signal (S(ƒ)) in order to obtain a corrected transmission signal (S_{pd}(ƒ)).

8. The transmitter according to claim 7 capable of performing a method of coding data, wherein a coding signal (ψₙ(ƒ), n=1, . . . , N) is used for coding data symbols (d₁, d₂, . . . , d_{N}), said coding signal (ψₙ(ƒ)) comprising an orthogonal component (ψₙ⁰(ƒ)) and an error component (Δψₙ(ƒ)), wherein a transmission signal (S(ƒ)) depending on said data symbols (d₁, d₂, . . . , d_{N}) and said coding signal (ψₙ(ƒ)) is obtained by said coding, wherein the transmission signal (S(ƒ)) is preferably obtained according to the equation
$$S ( f ) = {\sum }_{n = 1}^{N} {d}_{n} {ψ}_{n} ( f ) ,$$
wherein N is the number of data symbols (d₁, d₂, . . . , d_{N}) to be coded, the method determining a correction function (ξ(ƒ)) and applying said correction function (ξ(ƒ)) to said transmission signal (S(ƒ)) in order to obtain a corrected transmission signal (S_{pd}(ƒ)).
